(19) United States
(12) Patent Application Publication
(10) Pub. No.: US 2017/0326930 A1
(43) Pub. Date: Nov. 16, 2017

(54) TRAILER COUPLER LOCKING DEVICE

(71) Applicants: Richard Huff, Marana, AZ (US); Kristy Moore, Marana, AZ (US); Wynell Welch, Marana, AZ (US)

(72) Inventors: Richard Huff, Marana, AZ (US); Kristy Moore, Marana, AZ (US); Wynell Welch, Marana, AZ (US)

(21) Appl. No.: 15/585,284

(22) Filed: May 3, 2017

Related U.S. Application Data
(60) Provisional application No. 62/335,104, filed on May 12, 2016.

(51) Int. Cl. B60D 1/60; B60D 1/06

(52) U.S. Cl. CPC B60D 1/60; B60D 1/06

(57) ABSTRACT

A trailer coupler locking device that includes: a trailer ball body, wherein the trailer ball body is shaped as a coupling ball; a plurality of locking rods, where the plurality of locking rods define elongated members which extend from the trailer ball body; and a locking mechanism. The elongated members may be placed in either a locked position or an unlocked position. When in the unlocked position, the ball body moves freely in and out of a ball mount coupler, and when in a locked position, the ball body is locked into a ball mount coupler. The locking rods selectively extend and retract by manual operation of the locking mechanism, where the locking mechanism includes a cylinder lock that is operably connected to a rotational member and a mechanical rod actuator. The mechanical rod actuator operable connects the rotational member with each locking rod and enables each locking rod to move linearly in response to the rotary motion of the rotational member.

### CROSS REFERENCE TO OTHER APPLICATIONS

This application claims priority to U.S. Provisional Application Ser. No. 62/335,104 filed on May 12, 2016.

### BACKGROUND OF THE INVENTION

### Field of the Invention

The present invention relates generally to security devices and, more particularly, to a locking trailer ball which may be secured to a trailer coupler to prevent the trailer coupler from being attached to a trailer hitch.

### Description of the Prior Art

The use and design of trailer hitch assemblies to allow for the attachment of trailers to a towing vehicle to be transported is well established. Generally, a trailer will include a trailer coupler which can attach to a trailer ball of a trailer hitch on a motor vehicle in order to be towed by the motor vehicle. It is understood however, that once the trailer is brought to an intended destination, it is common for the trailer to be detached from the motor vehicle until it is desired to move the trailer again. While the trailer coupler is disconnected, however, a problem which still exists is that the trailer may become a target for theft if an individual can simply attach the trailer coupler to a trailer ball on a trailer hitch mounted to another motor vehicle and just drive away. Thus, there remains a need for a locking device which may be secured to the trailer coupler when it is not connected to a vehicle hitch trailer ball. It would be helpful if such a trailer coupler locking device operated to prevent the trailer coupler to which it was attached from being attached to a vehicle hitch trailer ball until removed from the trailer coupler. It would be additionally desirable for such a trailer coupler locking device to utilize a plurality of key operated rods which prevented it from being removed while in a locked position.

It is therefore an object of the present invention to provide a trailer coupler locking device adapted to allow a user to secure the trailer coupler of a trailer. The primary components of the present invention include a trailer ball body, locking rods, and a locking mechanism. When in operation, the trailer coupler locking device enables a user to selectively prevent a trailer coupler from being attached to a vehicle's hitch ball. As a result, many of the limitations imposed by prior art structures are removed.

### SUMMARY OF THE INVENTION

The present invention relates to a trailer coupler locking device that includes: a trailer ball body, wherein the trailer ball body is shaped as a coupling ball; a plurality of locking rods, where the plurality of locking rods define elongated members which extend from the trailer ball body; and a locking mechanism. The elongated members may be placed in either a locked position or an unlocked position. When in the unlocked position, the ball body moves freely in and out of a ball mount coupler, and when in a locked position, the ball body is locked into a ball mount coupler. The locking rods selectively extend and retract by manual operation of the locking mechanism, where the locking mechanism includes a cylinder lock that is operably connected to a rotational member and a mechanical rod actuator. The mechanical rod actuator operable connects the rotational member with each locking rod and enables each locking rod to move linearly in response to the rotary motion of the rotational member.

### BRIEF DESCRIPTION OF THE DRAWINGS

FIG. 1 depicts a side elevational view of a trailer coupler locking device built in accordance with the present invention in its unlocked configuration.

FIG. 2 depicts a bottom plan view of a trailer coupler locking device built in accordance with the present invention in its unlocked configuration.

FIG. 3 depicts a side elevational view of a trailer coupler locking device built in accordance with the present invention in its locked configuration.

FIG. 4 depicts a top plan view of a trailer coupler locking device built in accordance with the present invention in its locked configuration.

FIG. 5 depicts a side elevational view of cross section of a trailer coupler locking device built in accordance with the present invention in its unlocked configuration.

### DETAILED DESCRIPTION OF THE INVENTION

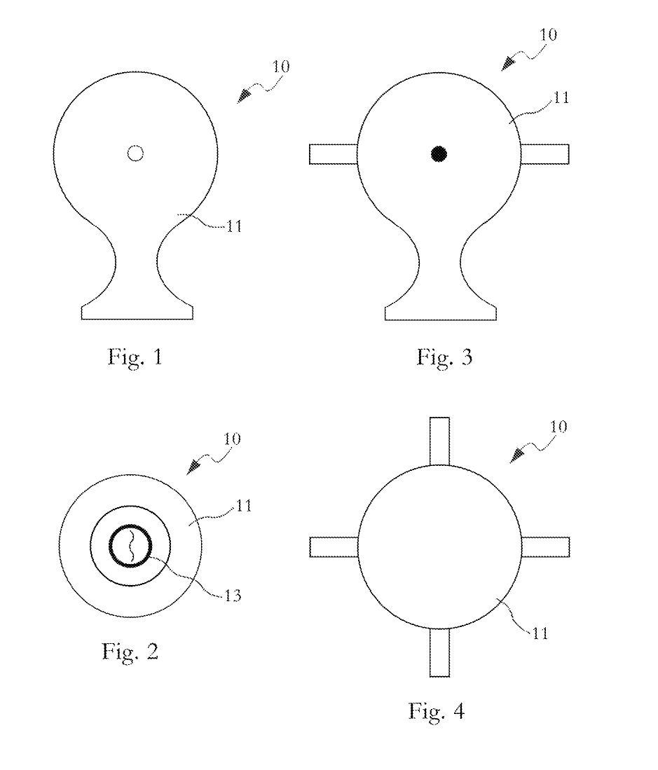

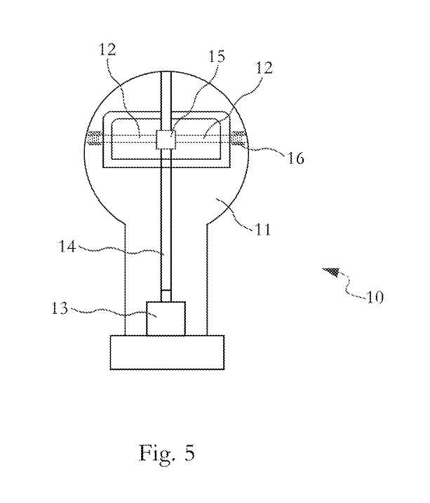

Referring now to the drawings and in particular FIGS. 1-5, a trailer coupler locking device 10 is shown having a trailer ball body 11, a plurality of locking rods 12, and a locking mechanism. The trailer ball body 11 is sized and shaped as a trailer ball so as to allow it to be inserted when in its unlocked configuration into a conventional ball mount coupler (not shown) of a trailer coupler. In various embodiments, the trailer ball body 11 is of a 1⅞ inch, 2 inch, or 2 5-16 inch size.

The locking rods 12 each define rigid, elongated members which may be selectively extended from the ball body 11 from a locked position, as illustrated by FIGS. 1 and 2, to a locked position, as illustrated by FIGS. 3 and 4. It is appreciated that when the rods 12 are in the unlocked position, the trailer coupler locking device 10 is in its unlocked configuration which allows the ball body 11 to be freely moved in and out of a ball mount coupler and when the rods 12 are in the locked position, the trailer coupler locking device 10 is in its locked configuration which locks the ball body 11 into a ball mount coupler (preventing any other ball mount from being positioned in the ball mount coupler).

The locking rods 12 are selectively extended and retracted by manual operation of the locking mechanism. The locking mechanism includes a cylinder lock 13 that is operably connected a rotational member 14 and a mechanical rod actuator 15 which operable connects the rotational member 14 with each rod 12 so as to move the rods 12 linearly in response to the rotary motion of the rotational member 14.

In one embodiment, a spring member 16 for each rod 12 is integral with the rod actuator 15. The spring member 16 biases the rod 12 with which it is coupled in an outward direction, thereby biasing each rod 12 towards its locked position. In this regard, it is contemplated that by turning the cylinder lock 13 with a key (not shown), the rods 12 are each pulled and locked the unlocked position and that by removing the key, the rods 12 return to the locked position.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A trailer coupler locking device comprising:
a trailer ball body, wherein the trailer ball body is shaped as a coupling ball;
a plurality of locking rods, where the plurality of locking rods define elongated members which extend from the trailer ball body; and
a locking mechanism.

2. The trailer coupler locking device according to claim 1, where the elongated members are placed in either a locked position or an unlocked position.

3. The trailer coupler locking device according to claim 2, where when in the unlocked position, the ball body moves freely in and out of a ball mount coupler, and when in a locked position, the ball body is locked into a ball mount coupler.

4. The trailer coupler locking device according to claim 1, where the locking rods selectively extended and retracted by manual operation of the locking mechanism.

5. The trailer coupler locking device according to claim 1, where the locking mechanism includes a cylinder lock that is operably connected a rotational member and a mechanical rod actuator, where the mechanical rod actuator operable connects the rotational member with each locking rod and enables each locking rod to move linearly in response to the rotary motion of the rotational member.

6. The trailer coupler locking device according to claim 5, where a spring member for each locking rod is integral with the rod actuator, and said spring member biases the locking rod in an outward direction towards its locked position.
